(19) United States
(12) Patent Application Publication
(10) Pub. No.: US 2024/0393735 A1
(43) Pub. Date: Nov. 28, 2024

(54) UNLOCKING CARTRIDGE CHAMBER DOOR FOR CARTRIDGE OF TONER

(71) Applicant: Hewlett-Packard Development Company, L.P., Spring, TX (US)

(72) Inventors: Jongin KIM, Seongnam Si (KR); Junhui KIM, Seongnam Si (KR); Jeonghyun LEE, Seongnam Si (KR)

(21) Appl. No.: 18/688,091

(22) PCT Filed: Feb. 9, 2022
(86) PCT No.: PCT/US2022/015760

§ 371 Date: Feb. 29, 2024

(30) Foreign Application Priority Data
Sep. 6, 2021 (KR) 10-2021-0118635

(51) Int. Cl. G03G 21/16; G03G 15/08

(52) U.S. Cl. CPC G03G 21/1647; G03G 15/0865; G03G 21/1633

(57) ABSTRACT

An example image forming apparatus includes a main body including a cartridge chamber, a toner cartridge movable between a mounting position in which the toner cartridge is mounted in the cartridge chamber and a pop-up position in which the toner cartridge protrudes from the cartridge chamber, and a chamber door to open and close the cartridge chamber, wherein the chamber door is to switch to an open position to open the cartridge chamber in association with a pop-up operation of the toner cartridge.

### BACKGROUND

An image forming apparatus using an electrophotographic method is a printer that supplies toner to an electrostatic latent image formed on a photoconductor to form a visible toner image on the photoconductor, transfers the toner image to a print medium via an intermediate transfer medium or directly to a print medium, and fixes the transferred toner image on the print medium.

The image forming apparatus may include a toner cartridge that is removably mounted in a main body. The toner cartridge may be replaced in a situation in which toner therein runs out. Based on toner contained in the toner cartridge being consumed, the toner cartridge may be removed from the main body, and a new toner cartridge may be attached to the main body.

### BRIEF DESCRIPTION OF THE DRAWINGS

Various examples will be described below by referring to the following figures.

FIG. 1 illustrates an image forming apparatus according to an example.

FIG. 2 is an exploded perspective view of a locking member according to an example.

FIGS. 3 to 5 are cross-sectional views illustrating a process in which a chamber door is unlocked by a pop-up operation of a toner cartridge according to an example.

FIG. 6 is a schematic view illustrating a relationship between a latching portion and a locking portion based on a chamber door being switched to a closed position according to an example.

FIG. 7 is an exploded perspective view of a pop-up member according to an example.

FIG. 8 is a view illustrating the appearance of a pop-up member based on a toner cartridge being located in a mounting position according to an example.

FIG. 9 is a view illustrating the appearance of a pop-up member based on a toner cartridge being located in a pop-up position according to an example.

FIG. 10 is a partial perspective view of a locking member according to an example.

FIG. 11 is an exploded perspective view of the locking member shown in FIG. 10 according to an example.

FIGS. 12 to 14 are cross-sectional views illustrating a process in which a chamber door is unlocked by a pop-up operation of a toner cartridge according to an example.

### DETAILED DESCRIPTION

An image forming apparatus that prints an image on a print medium by an electrophotographic method includes a replaceable toner cartridge. A cartridge chamber in which a toner cartridge may be mounted may be provided in a main body of the image forming apparatus. In order to replace the toner cartridge, a main door provided in the main body may be opened to expose an entrance of the cartridge chamber. The toner cartridge may be removed from the cartridge chamber, a new toner cartridge may be installed into the cartridge chamber, and the main door may be closed. According to a structure in which a toner cartridge is exposed based on a main door being opened, a user may cause an error in the image forming apparatus by arbitrarily replacing a toner cartridge without going through an appropriate replacement procedure. In addition, a user may arbitrarily replace a toner cartridge before the toner contained in the toner cartridge is exhausted, resulting in unnecessary cost of consumables.

An image forming apparatus according to an example includes a chamber door for opening and closing a cartridge chamber and a locking member to lock the chamber door in a closed position to close the cartridge chamber. The toner cartridge may be located in a mounting position in which it is mounted in the cartridge chamber and a pop-up position in which it protrudes from the cartridge chamber. The locking member may interfere with the toner cartridge based on the toner cartridge being popped up, and may be switched between a locking position and an unlocking position. The unlocking position of the locking member is a position that unlocks the chamber door to allow the chamber door to be switched to an open position to open the cartridge chamber.

In a state in which the toner cartridge is not popped up, the chamber door may be closed so that the toner cartridge is not exposed from the cartridge chamber. In that case, arbitrary replacement of the toner cartridge may be prevented. Because the chamber door may be unlocked by the pop-up operation of the toner cartridge, there is no need to provide an additional driving source for unlocking the chamber door. Because the toner cartridge pops up and partially protrudes from the cartridge chamber, a user may remove the toner cartridge from the cartridge chamber.

The locking member may be provided at a position in which a user cannot arbitrarily switch the locking member to the unlocking position. The locking member may be located within a space defined by the chamber door and the cartridge chamber. Accordingly, even in a situation in which the main door is opened, the locking member may not be exposed. For example, the locking member may be installed on an inner portion of the chamber door. For example, the locking member may be installed in the cartridge chamber. The locking member to unlock the chamber door by interference with the popped-up toner cartridge may be implemented in various forms. Hereinafter, examples of the image forming apparatus will be described with reference to the drawings. In the drawings, the same reference numerals refer to components having the same function, and the size of each component may be exaggerated for clarity and convenience of description.

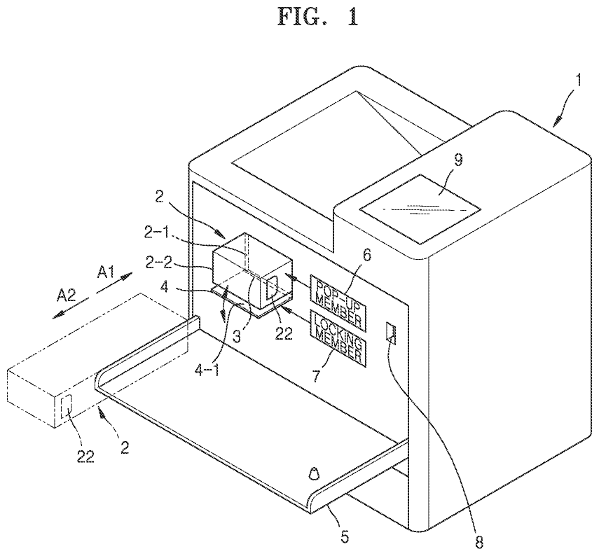

FIG. 1 illustrates an image forming apparatus according to an example.

Referring to FIG. 1, the image forming apparatus may include a main body 1 having a cartridge chamber 3, a toner cartridge 2 movable between a mounting position 2-1 mounted in the cartridge chamber 3 and a pop-up position 2-2 protruding from the cartridge chamber 3, and a chamber door 4 to open and close the cartridge chamber 3 The chamber door 4 may be switched between a closed position to close the cartridge chamber 3 and an open position to open the cartridge chamber 3, in association with a pop-up operation of the toner cartridge 2. A closed position of the chamber door 4 refers to a position where an entrance of the cartridge chamber 3 is blocked, so that the toner cartridge 2 cannot be mounted/removed to/from the cartridge chamber 3. The open position refers to a position where the entrance of the cartridge chamber 3 is opened, so that the toner cartridge 2 may be mounted/removed to/from the cartridge chamber 3. The image forming apparatus may include a pop-up member 6 for popping up the toner cartridge between the mounting position 2-1 and the pop-up position 2-2 and a locking member 7 for locking the chamber door 4 in the closed position. The locking member 7 may be switched between a locking position and an unlocking position allowing the chamber door 4 to be switched to the open position, by interfering with the toner cartridge 2 based on the toner cartridge 2 being popped up. The pop-up member 6 may be provided in the main body 1.

The main body 1 of the image forming apparatus includes a printing unit for printing an image on a print medium by an electrophotographic method. The printing unit may include a photoconductor, a charger, an optical scanner, a developing unit, a transfer unit, and a fixing unit. The optical scanner is to scan light modulated according to image information on a surface of the photoconductor charged with a uniform electric surface potential to form an electrostatic latent image on the surface of the photoconductor. The developing unit is to supply toner to the electrostatic latent image to develop the electrostatic latent image into a visible toner image. The transfer unit is to transfer the toner image formed on the surface of the photoconductor to the print medium. The transferred toner image is attached to the print medium by an electrostatic force. The fixing unit is to apply heat and pressure to the toner image to fix the toner image on the print medium. The toner cartridge 2 may be connected to the developing unit to supply toner to the developing unit. Based on the toner contained in the toner cartridge 2 being exhausted, the toner cartridge 2 may be replaced with a new toner cartridge.

The cartridge chamber 3 may be provided in the main body 1 of the image forming apparatus. The chamber door 4 may be provided at the entrance of the cartridge chamber 3. The chamber door 4 is to open and close the cartridge chamber 3. The chamber door 4 may be switched, for example, pivoted, between a closed position to close the cartridge chamber 3 and an open position to open the cartridge chamber 3. The locking member 7 is to lock the chamber door 4 in the closed position. The pop-up member 6 may pop-up the toner cartridge 2 between a mounting position (the position shown by dashed lines in FIG. 1) mounted in the cartridge chamber 3 to a pop-up position (the position shown by solid lines in FIG. 1) protruding from the cartridge chamber 3. A pop-up position of the toner cartridge 2 may be a position where a user may grip a front end of the toner cartridge 2. For example, the pop-up position of the toner cartridge 2 may be a position where a user may grip a handle 22 provided on the side of the toner cartridge 2. The locking member 7 may be switched from the locking position to the unlocking position to allow the chamber door 4 to be pivoted between the closed position and the open position, in association with the pop-up operation of the toner cartridge 2. A main door 5 is to open a portion of the main body 1. A door opening/closing sensor 8 is to detect whether the main door 5 is opened or closed. Based on the main door 5 being opened, the chamber door 4 is exposed, and, with the chamber door 4 located in the open position, the toner cartridge 2 may be mounted/removed to/from the cartridge chamber 3 by sliding the toner cartridge 2 in a mounting direction A1 or a removal direction A2.

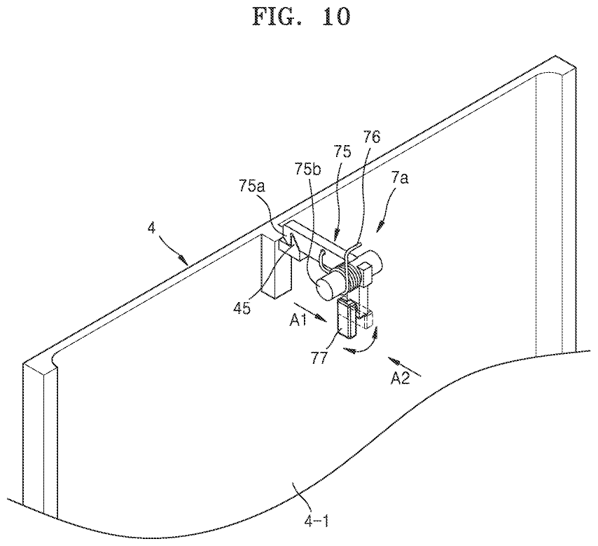

In order to prevent a user from arbitrarily unlocking the chamber door 4, the locking member 7 may be arranged at a position that is not exposed in a situation in which the main door 5 is opened. The locking member 7 may be located in a space defined by the chamber door 4 and the cartridge chamber 3. For example, the locking member 7 may be located on an inner portion 4-1 of the chamber door 4. The inner portion 4-1 includes a portion of the chamber door 4 which faces the inside of the cartridge chamber 3 based on the chamber door 4 being located in the closed position. For example, a locking member (e.g., 7a of FIG. 10) may be located inside the cartridge chamber 3. Based on the chamber door 4 being located in the closed position, the locking member (e.g., 7a of FIG. 10) is not exposed to the outside.

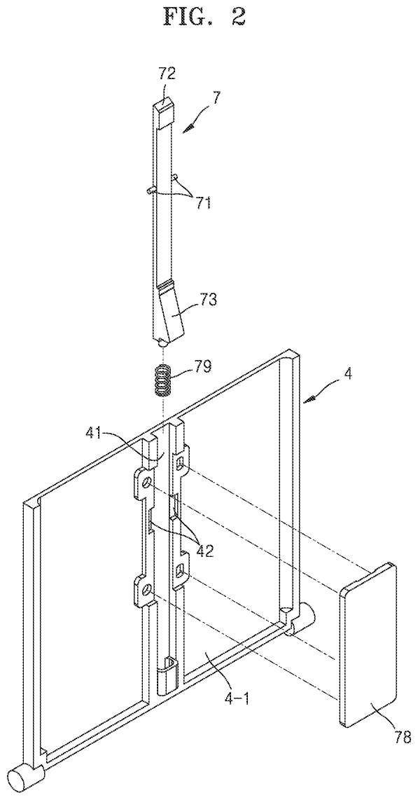

FIG. 2 is an exploded perspective view of a locking member according to an example.

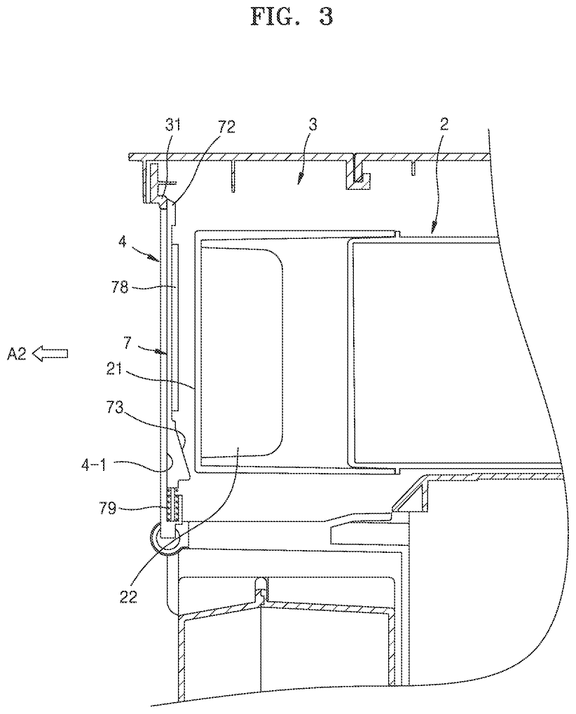

Referring to FIG. 2, the locking member 7 may be provided on the inner portion 4-1 of the chamber door 4. The locking member 7 may be slidably supported between a locking position and an unlocking position on the inner portion 4-1 of the chamber door 4. A sliding direction of the locking member 7 may be a direction orthogonal to a pop-up direction of the toner cartridge 2, that is, the removal direction A2. Hereinafter, the pop-up direction and the removal direction are denoted by reference numeral A2. A slide groove 41 extending in a vertical direction may be provided in the inner portion 4-1 of the chamber door 4. The locking member 7 may be inserted into the slide groove 41. A locking portion 72 may be provided at an upper end of the locking member 7. The locking portion 72 may be caught by a latching portion (e.g., 31 of FIG. 3) provided in the main body 1, which will be described later below, based on the locking member 7 being located in the locking position. An elastic member 79 may apply an elastic force in a direction toward the locking position to the locking member 7. For example, the elastic member 79 may be implemented by a compression coil spring interposed between a lower end of the locking member 7 and the chamber door 4 to push the locking member 7 upward. A stopper structure may be provided to prevent the locking member 7 from moving beyond the locking position. The stopper structure may include a pair of limiting slots 42 on both sides of the slide groove 41 and a pair of protrusions 71 provided on the locking member 7 to be respectively inserted into the pair of limiting slots 42. Based on the locking member 7 reaching the locking position, the pair of protrusions 71 may be caught by upper ends of the pair of limiting slots 42 and stop. A cover 78 may be coupled to the inner portion 4-1 of the chamber door 4 so that the locking member 7 may not be removed from the slide groove 41.

The locking member 7 may be provided with an interference structure to interfere with the toner cartridge 2. As an example, the interference structure of the locking member 7 may interfere with the toner cartridge 2 being moved to the pop-up position to slide the locking member 7 to the unlocking position. As an example of the interference structure, the locking member 7 may have an inclined interference portion 73. The inclined interference portion 73 is to interfere with the popped-up toner cartridge 2. The inclined interference portion 73 may be inclined with respect to the pop-up direction of the toner cartridge 2, that is, the removal direction A2, to interfere with the popped-up toner cartridge 2 and move the locking member 7 to the unlocking position.

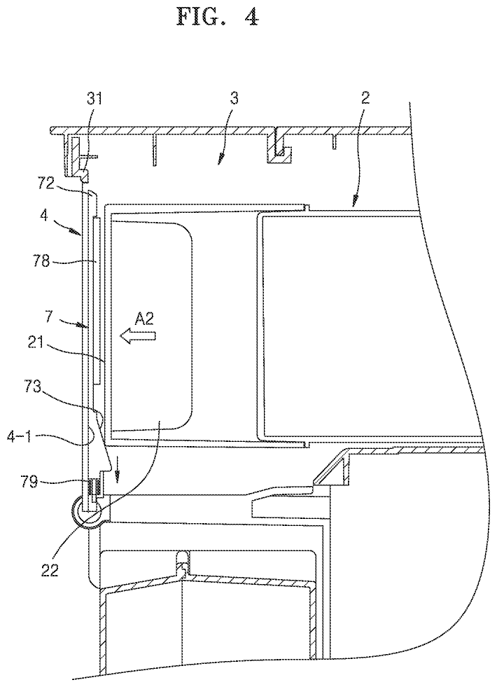

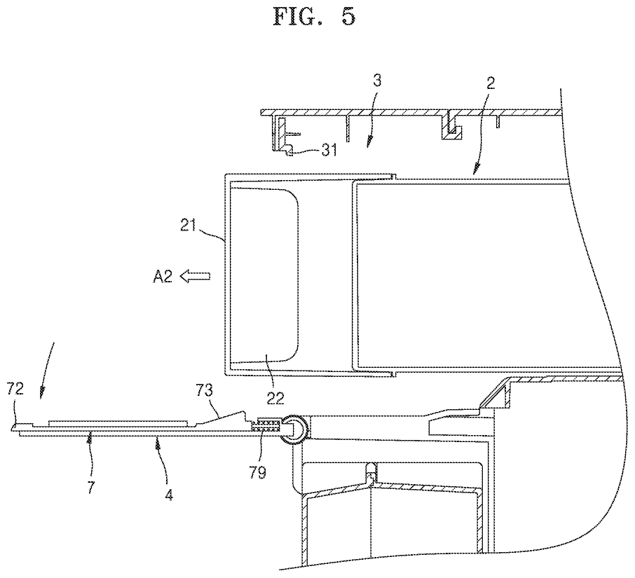

FIGS. 3 to 5 are cross-sectional views illustrating a process in which a chamber door is unlocked by a pop-up operation of a toner cartridge according to an example. FIG. 3 shows a state in which the chamber door 4 is located in a closed position, the locking member 7 is located in a locking position, and the toner cartridge 2 is located in a mounting position according to an example. FIG. 4 shows a state in which the locking member 7 is located in an unlocking position according to an example. FIG. 5 shows a state in which the toner cartridge 2 reaches a pop-up position according to an example.

Referring to FIG. 3, the toner cartridge 2 may be inserted into the cartridge chamber 3 and located in the mounting position. A front end 21 of the toner cartridge 2 may be apart from the inclined interference portion 73 of the locking member 7. The chamber door 4 may be located in a closed position to block the entrance of the cartridge chamber 3. The locking member 7 may be located in the locking position. The locking portion 72 provided at an upper end of the locking member 7 may be caught by a latching portion 31 provided in the main body 1. The locking member 7 may be maintained in the locking position by an elastic force of the elastic member 79. Based on the chamber door 4 being locked in the closed position, the toner cartridge 2 is not exposed, even in a situation in which the main door 5 is opened. Further, because the locking member 7 is provided on the inner portion 4-1 of the chamber door 4, a user cannot access the locking member 7. Therefore, the chamber door 4 cannot be opened arbitrarily, and the toner cartridge 2 cannot be removed from the cartridge chamber 3 arbitrarily.

In the state shown in FIG. 3, the pop-up member 6 may push the toner cartridge 2 in a pop-up direction A2. As the toner cartridge 2 is moved in the pop-up direction A2, as shown in FIG. 4, the front end 21 of the toner cartridge 2 may be brought into contact with the inclined interference portion 73 to push the inclined interference portion 73 in the pop-up direction A2. While the locking member 7 is lowered, the locking portion 72 is released from the latching portion 31. The locking member 7 may be located in the unlocking position, and the chamber door 4 may be in a state in which the chamber door 4 can be rotated to the open position. The toner cartridge 2 may still be located inside the cartridge chamber 3.

Based on the pop-up member 6 further pushing the toner cartridge 2 in the pop-up direction A2 in the state shown in FIG. 4, the front end 21 of the toner cartridge 2 may come into contact with the chamber door 4, and the front end 21 may rotate the chamber door 4 to the open position as shown in FIG. 5. The locking member 7 may be returned to the locking position by the elastic force of the elastic member 79. The toner cartridge 2 may reach a pop-up position where the front end 21 may protrude from the cartridge chamber 3. In this state, a user may remove the toner cartridge 2 from the cartridge chamber 3 by holding the exposed front end 21 of the toner cartridge 2 and pulling the toner cartridge 2 in the removal direction A2. As described above, the toner cartridge 2 may be provided with the handle 22. The handle 22 may be located on a side of the toner cartridge 2. For example, the handle may be located on the side of the toner cartridge 2 in the form of being embedded from the side of the toner cartridge 2. A pop-up position of the toner cartridge 2 may be a position where the handle 22 is at least partially exposed to the outside of the cartridge chamber 3 as shown in FIG. 5. A user may remove the toner cartridge 2 from the cartridge chamber 3 by holding the handle 22 and pulling the toner cartridge 2 in the removal direction A2.

The user may mount the toner cartridge 2 into the cartridge chamber 3 by pushing the toner cartridge 2 in the mounting direction A1 with the chamber door 4 located in the open position. After pushing the toner cartridge 2 into the cartridge chamber 3 in the mounting position A1, the user may rotate the chamber door 4 to position the chamber door 4 in the closed position.

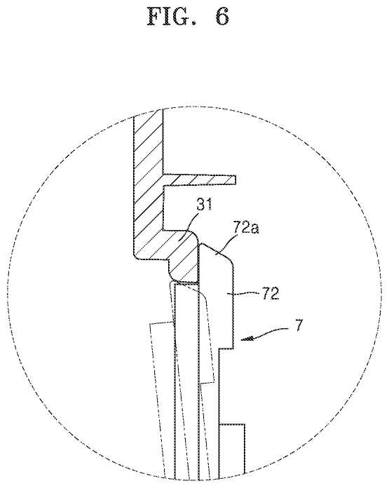

FIG. 6 is a schematic view illustrating a relationship between a latching portion and a locking portion based on a chamber door being switched to a closed position according to an example.

Referring to FIG. 6, because the locking member 7 may be located in the locking position by an elastic force of the elastic member 79, based on the chamber door 4 being closed, the locking portion 72 interferes with the latching portion 31. In order for the locking member 7 to be easily moved in a direction opposite to the elastic force of the elastic member 79, that is, toward an unlocking position, by interference with the latching portion 31, an inclined portion 72a may be provided in the locking portion 72. The inclined portion 72a may be formed, for example, by rounding or chamfering the end of the locking portion 72. Based on the chamber door 4 approaching the closed position, the inclined portion 72a of the locking portion 72 interferes with the latching portion 31 so that the locking member 7 may be pushed in the direction opposite to the elastic force of the elastic member 79 as shown by dashed lines in FIG. 6. Based on the chamber door 4 reaching the closed position, interference between the inclined portion 72a and the latching portion 31 is terminated based on the locking portion 72 being out of the latching portion 31. The locking member 7 may be returned to the locking position by the elastic force of the elastic member 79. The locking portion 72 may be caught by the latching portion 31 so that the chamber door 4 may be locked in the closed position.

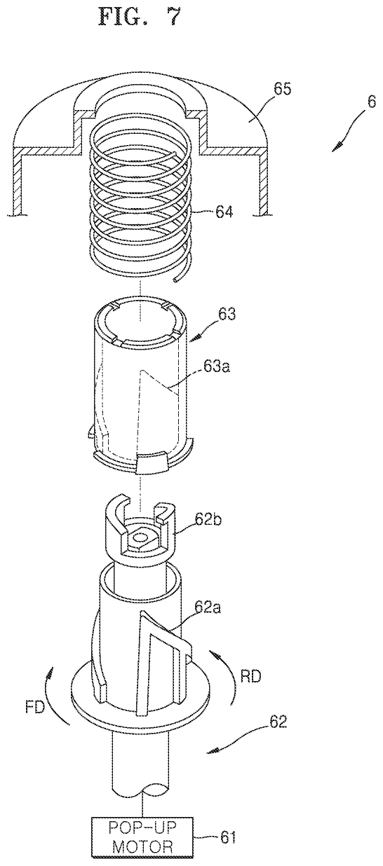

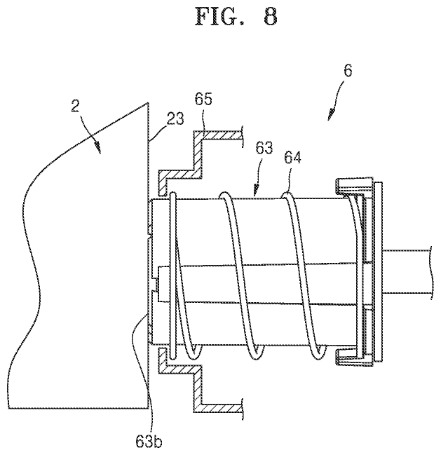

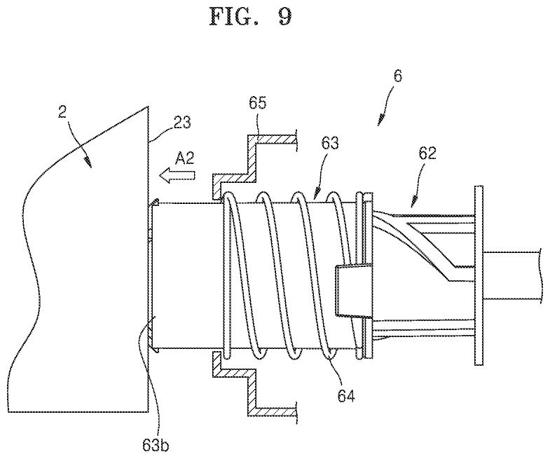

The pop-up member 6 for popping up the toner cartridge 2 from the mounting position to the pop-up position may be implemented in various forms. FIG. 7 is an exploded perspective view of a pop-up member according to an example. FIG. 8 is a view illustrating the appearance of a pop-up member based on a toner cartridge being located in a mounting position according to an example. FIG. 9 is a view illustrating the appearance of a pop-up member based on a toner cartridge being located in a pop-up position according to an example.

Referring to FIGS. 7 to 9, the pop-up member 6 may include a coupling member 62, a push member 63, and a return spring 64. The coupling member 62 may be rotated by a pop-up motor 61. The coupling member 62 may include a first inclined portion 62a and a driving coupler 62b. The driving coupler 62b may engage with a driven coupler (not shown) provided in the toner cartridge 2 based on the toner cartridge 2 being located in a mounting position to transmit a rotational force of the pop-up motor 61 to the toner cartridge 2. The push member 63 may be connected to the coupling member 62. The push member 63 is to push the toner cartridge 2 to a pop-up position based on the coupling member 62 being rotated in a reverse direction RD. For example, the push member 63 may be a hollow cylindrical member, and be provided with a second inclined portion 63a having a shape complementary to that of the first inclined portion 62a on an inner circumferential surface. The coupling member 62 may be inserted into the push member 63 so that the first inclined portion 62a and the second inclined portion 63a are engaged with each other. The first inclined portion 62a and the second inclined portion 63a may be formed such that the push member 63 advances in an axial direction based on the coupling member 62 being driven in the reverse direction RD by the pop-up motor 61. Furthermore, the push member 63 and the coupling member 62 may be rotated together based on the coupling member 62 being driven in a forward direction FD by the pop-up motor 61. The return spring 64 may apply an elastic force in a direction of returning to the original position to the push member 63. For example, the return spring 64 may be implemented by a compression coil spring having one end and the other end supported by a pop-up housing 65 and the push member 63, respectively.

Referring to FIG. 8, based on the toner cartridge 2 being located in a mounting position, a front end 63b of the push member 63 may be brought into contact with a rear end 23 of the toner cartridge 2. The driving coupler 62b is to engage with a driven coupler (not shown) of the toner cartridge 2. A rotational force in the forward direction FD of the pop-up motor 61 may be transmitted to the driven coupler of the toner cartridge 2 by the driving coupler 62b, so that a component inside the toner cartridge 2, for example, a stirrer or the like may be driven. Based on the coupling member 62 being driven in the reverse direction RD by the pop-up motor 61, the push member 63 may be moved in the pop-up direction A2 with respect to the coupling member 62 by the action of the first inclined portion 62a and the second inclined portion 63a. The push member 63 is to push the rear end 23 of the toner cartridge 2 in the pop-up direction A2. Thereby, the toner cartridge 2 may be moved to the pop-up position.

With reference to FIGS. 1 to 9, an example process of replacing the toner cartridge 2 will be briefly described. For example, based on the remaining amount of toner inside the toner cartridge 2 being equal to or less than the standard remaining amount corresponding to a replacement time of the toner cartridge 2, a replacement message of the toner cartridge 2 may be output through a user interface 9. Based on detecting that the main door 5 is opened by the door opening/closing sensor 8, a message requesting input of a toner cartridge replacement command may be output on the user interface 9. The chamber door 4 may be locked in the closed position. Based on a toner cartridge replacement command being input through the user interface 9, the pop-up motor 61 may rotate the coupling member 62 in the reverse direction RD. While the push member 63 is moved in the pop-up direction A2 with respect to the coupling member 62, the toner cartridge 2 may be pushed in the pop-up direction A2. Thereby, as shown in FIG. 4, the locking member 7 may be slid to the unlocking position, and the chamber door 4 may be unlocked. Based on the push member 63 pushing the toner cartridge 2 further in the pop-up direction A2, the chamber door 4 may be pushed against the toner cartridge 2 and pivoted from the closed position to the open position, and, as shown in FIG. 5, the toner cartridge 2 may reach the pop-up position. A user may remove the toner cartridge 2 from the cartridge chamber 3 by holding the exposed handle 22 and pulling the toner cartridge 2 in the removal direction A2. Based on the pop-up motor 61 rotating in the forward direction FD, the push member 63 may be returned to its original position as shown in FIG. 8 by an elastic force of the return spring 64. The user may insert the toner cartridge 2 back into the cartridge chamber 3 to place the toner cartridge 2 in the mounted position, return the chamber door 4 in the closed position, and may close the main door 5.

According to an example, because the chamber door 4 may be unlocked by the operation of the user interface 9, arbitrary replacement of the toner cartridge 2 can be prevented. In addition, because the chamber door 4 located in the closed position may be unlocked by a pop-up operation of the toner cartridge 2, providing a separate actuator for unlocking the chamber door 4, for example, a solenoid, may be avoided. That is, the locking member 7 may be driven by the pop-up motor 61 that drives parts inside the toner cartridge 2 and pops up the toner cartridge 2. Therefore, an increase in the number of parts for unlocking the chamber door 4 and an accompanying increase in material cost may be reduced. Because the toner cartridge 2 pops up, a user may remove the toner cartridge 2 from the cartridge chamber 3.

In the above-described example, the chamber door 4 may be rotated up and down to switch between the open position and the closed position. However, the chamber door 4 may be rotated laterally to switch between the open position and the closed position. In the above example, the locking member 7 may be slid in the vertical direction to switch between the locking position and the unlocking position. However, the locking member 7 may be slid in any direction intersecting the pop-up direction A2 of the toner cartridge 2 to switch between the locking position and the unlocking position. For example, “any direction” may be a direction orthogonal to the pop-up direction A2, but is not necessarily limited thereto.

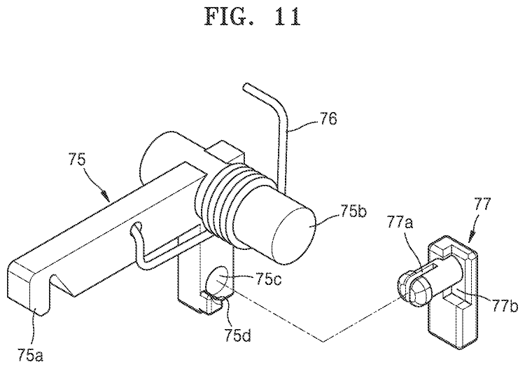

FIG. 10 is a partial perspective view of a locking member according to an example. FIG. 11 is an exploded perspective view of the locking member shown in FIG. 10 according to an example.

Referring to FIGS. 10 and 11, the locking member 7a may be installed inside the cartridge chamber 3, for example, on an upper wall of the cartridge chamber 3. The locking member 7a may be installed near the entrance of the cartridge chamber 3. The locking member 7a may include a locking lever 75, an elastic member 76, and an interference lever 77. The locking lever 75 may be pivoted between a locking position to lock the chamber door 4 in a closed position and an unlocking position to allow the chamber door 4 to be switched to an open position about an axis 75b. The locking lever 75 may be provided with a locking hook 75a to be hooked on a latching portion 45 provided on the chamber door 4. The latching portion 45 may be provided on the inner portion 4-1 of the chamber door 4. The locking lever 75 may be pivoted between the locking position in which the locking hook 75a is hooked on the latching portion 45 and the unlocking position in which the locking hook 75a is unlocked from the latching portion 45. The elastic member 76 is to apply an elastic force in a direction toward the locking position to the locking lever 75. For example, the elastic member 76 may be implemented by a torsion coil spring.

The interference lever 77 may be connected to the locking lever 75. The interference lever 77 is to interfere with the toner cartridge 2 that pops up so that the locking lever 75 may be pivoted to the unlocking position. The interference lever 77 may be connected to the locking lever 75 so that the interference lever 77 may be pivoted between an interference position (i.e., a position shown by solid lines in FIG. 10) and an escape position (i.e., a position shown by dashed lines in FIG. 10). The interference position may be a position of interference with the front end 21 of the toner cartridge 2 that is popped up, that is, moved in the pop-up direction A2. The escape position may be a position pivoted from the interference position to a position allowing mounting of the toner cartridge 2 by interfering with the rear end 23 of the toner cartridge 2 mounted in the cartridge chamber 3, that is, moved in the mounting direction A1. For example, a shaft 77a of the interference lever 77 may be inserted into a hole 75c provided in the locking lever 75. The interference lever 77 may not rotate with respect to the locking lever 75 based on the interference lever 77 interfering with the front end 21 of the toner cartridge 2 that is moved from the mounting position in the pop-up direction A2. To this end, a first stopper 75d may be provided on the locking lever 75, and the interference lever 77 may be provided with a second stopper 77b to be caught by the first stopper 75d. Based on a force in the pop-up direction A2 being applied to the interference lever 77, the second stopper 77b may be caught by the first stopper 75d. Thus, the interference lever 77 may not rotate with respect to the locking lever 75 and remains in the interference position. Instead, the locking lever 75 and the interference lever 77 are rotated together about the axis 75b. Based on a force in the mounting direction A1 being applied to the interference lever 77, the interference lever 77 may be rotated with respect to the locking lever 75 as shown by the dashed lines in FIG. 10 to switch to the escape position. The escape position is a position where the toner cartridge 2 can be slid in the mounting direction A1 to be mounted in the cartridge chamber 3.

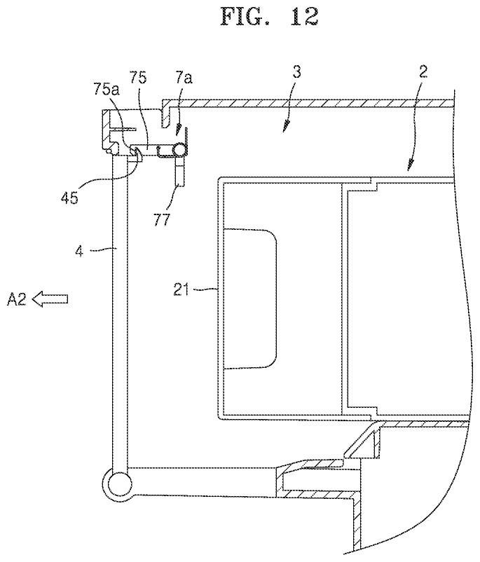

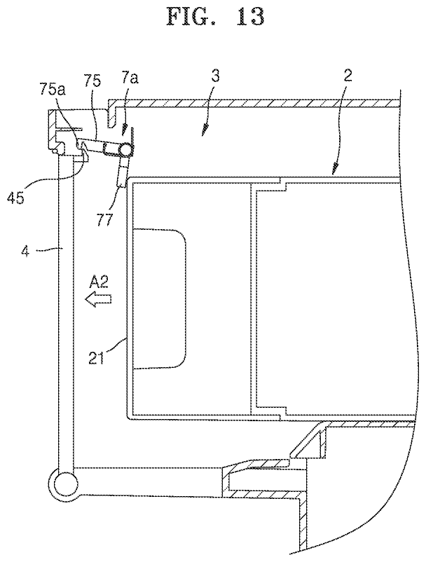

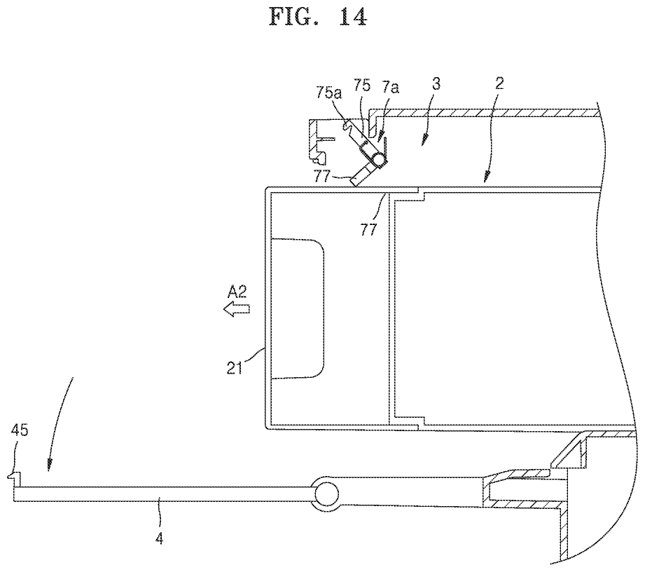

FIGS. 12 to 14 are cross-sectional views illustrating a process in which a chamber door is unlocked by a pop-up operation of a toner cartridge according to an example. FIG. 12 shows a state in which the chamber door 4 is located in a closed position, the locking lever 75 is located in a locking position, and the toner cartridge 2 is located in a mounting position according to an example. FIG. 13 shows a state in which the locking lever 75 is located in an unlocking position according to an example. FIG. 14 shows a state in which the toner cartridge 2 reaches a pop-up position according to an example.

Referring to FIG. 12, the toner cartridge 2 may be inserted into the cartridge chamber 3 and located in the mounting position. The front end 21 of the toner cartridge 2 may be apart from the interference lever 77 located at an interference position. The chamber door 4 may be located in a closed position to block the entrance of the cartridge chamber 3. The locking lever 75 may be located in a locking position. The locking hook 75a of the locking lever 75 may be caught by a latching portion 45 of the chamber door 4. The locking lever 75 may be maintained in the locking position by an elastic force of the elastic member 76. The chamber door 4 may be locked in the closed position. Even based on the main door 5 being opened, the toner cartridge 2 is not exposed. Because the locking member 7a is provided inside the cartridge chamber 3, a user cannot access the locking member 7a. Therefore, the chamber door 4 cannot be opened arbitrarily, and the toner cartridge 2 cannot be removed from the cartridge chamber 3 arbitrarily.

In the state shown in FIG. 12, the pop-up member 6 pushes the toner cartridge 2 in a pop-up direction A2. As the toner cartridge 2 is moved in the pop-up direction A2, as shown in FIG. 13, the front end 21 of the toner cartridge 2 may be brought into contact with the interference lever 77 to push the interference lever 77 in the pop-up direction A2. Because the second stopper 77b of the interference lever 77 may be in contact with the first stopper 75d of the locking lever 75, the interference lever 77 does not rotate with respect to the locking lever 75, and may be maintained at the interference position. Based on the toner cartridge 2 continuing to move in the pop-up direction A2, the locking lever 75 and the interference lever 77 may be rotated together about the axis 75b. The locking hook 75a of the locking lever 75 may be released from the latching portion 45 of the chamber door 4. The locking lever 75 may be located in an unlocking position, and the chamber door 4 may be in a state in which the chamber door 4 can be rotated to the open position. The toner cartridge 2 may still be located inside the cartridge chamber 3.

Based on the pop-up member 6 further pushing the toner cartridge 2 in the pop-up direction A2 in the state shown in FIG. 13, the front end 21 of the toner cartridge 2 may come into contact with the chamber door 4 and push the chamber door 4 to the open position and rotate the chamber door 4 as shown in FIG. 14. Because interference between the interference lever 77 and the toner cartridge 2 may be maintained, the locking lever 75 may be maintained in the unlocking position. The toner cartridge 2 reaches a pop-up position where the front end 21 protrudes from the cartridge chamber 3. In this state, a user may remove the toner cartridge 2 from the cartridge chamber 3 by holding the exposed front end 21 of the toner cartridge 2 and pulling the toner cartridge 2 in the removal direction A2. Based on the toner cartridge 2 being provided with the handle 22, the user may remove the toner cartridge 2 from the cartridge chamber 3 by holding the handle 22 partially exposed to the outside of the cartridge chamber 3 and pulling the toner cartridge 2 in the removal direction A2. Based on the removal of the toner cartridge 2 being completed, the interference between the toner cartridge 2 and the interference lever 77 ends, and the locking lever 75 may be returned to the locking position by the elastic force of the elastic member 76. The interference lever 77 may be returned to the interference position.

The user may mount the toner cartridge 2 in the cartridge chamber 3 by sliding the toner cartridge 2 in the mounting direction A1. The rear end 23 of the toner cartridge 2 interferes with the interference lever 77 located at the interference position, so that the user may push the interference lever 77 in the mounting direction A1. The interference lever 77 may be pivoted about the shaft 77a to the escape position as shown by the dashed lines in FIG. 10. Thus, the toner cartridge 2 may be inserted into the cartridge chamber 3. Based on the toner cartridge 2 approaching the mounting position, the interference between the interference lever 77 and the toner cartridge 2 ends, and the interference lever 77 may be returned to the interference position by, for example, its own weight. After pushing the toner cartridge 2 into the cartridge chamber 3 to the mounting position, the user may close the chamber door 4. At this time, the latching portion 45 of the chamber door 4 pushes the locking hook 75a of the locking lever 75 to slightly pivot the locking lever 75 toward the unlocking position. Based on the chamber door 4 reaching the closed position, the locking lever 75 may be returned to the locking position by the elastic force of the elastic member 76, and the locking hook 75a may be hooked on the latching portion 45, so that the chamber door 4 is locked in the closed position.

It should be understood that examples described herein should be considered in a descriptive sense and not for purposes of limitation. Descriptions of features or aspects within each example should typically be considered as available for other similar features or aspects in other examples. While examples have been described with reference to the figures, it will be understood that various changes in form and details may be made therein without departing from the spirit and scope as defined by the following claims.

What is claimed is:

1. An image forming apparatus comprising:
a main body including a cartridge chamber to mount a toner cartridge;
a pop-up member to pop up the toner cartridge from a mounting position to a pop-up position at which the toner cartridge protrudes from the cartridge chamber;
a chamber door to open and close the cartridge chamber; and
a locking member to be switched between a locking position to lock the chamber door in a closed position to close the cartridge chamber and an unlocking position to allow the chamber door to be switched to an open position to open the cartridge chamber by interfering with the toner cartridge in the pop-up position.

2. The image forming apparatus of claim 1, wherein, based on the locking member being in the unlocking position, the chamber door is to push against the toner cartridge in the pop-up position and switch to the open position.

3. The image forming apparatus of claim 1, wherein the chamber door includes the locking member.

4. The image forming apparatus of claim 3, wherein the locking member is slidably supported on an inner portion of the chamber door between the locking position and the unlocking position.

5. The image forming apparatus of claim 4, wherein the locking member is to slide in a direction perpendicular to a pop-up direction of the toner cartridge.

6. The image forming apparatus of claim 4, further comprising an elastic member to apply an elastic force to the locking member in a direction toward at the locking position,
wherein the locking member includes an inclined interference portion inclined with respect to a pop-up direction of the toner cartridge to interfere with the popped-up toner cartridge and to move the locking member to the unlocking position.

7. The image forming apparatus of claim 6,
wherein the locking member includes a locking portion which, based on the locking member being in the locking position, is to be caught on a latching portion provided on the main body, and
wherein the locking portion includes an inclined portion and is movable in a direction opposite to the elastic force of the elastic member by interfering with the latching portion based on the chamber door being closed.

8. The image forming apparatus of claim 1, wherein the cartridge chamber includes the locking member.

9. The image forming apparatus of claim 8, wherein the locking member comprises:
a locking lever including a locking hook to be hooked on a latching portion provided on the chamber door and pivotable between the locking position and the unlocking position;
an elastic member to apply an elastic force in a direction toward the locking position to the locking lever; and
an interference lever connected to the locking lever to interfere with the toner cartridge in the pop-up position to pivot the locking lever to the unlocking position.

10. The image forming apparatus of claim 9, wherein the interference lever is connected to the locking lever to rotate between an interference position of interference with the toner cartridge in the pop-up position and an escape position of interference with the toner cartridge mounted in the cartridge chamber to allow mounting of the toner cartridge.

11. An image forming apparatus comprising:
a main body including a cartridge chamber;
a toner cartridge movable between a mounting position in which the toner cartridge is mounted on the cartridge chamber and a pop-up position in which the toner cartridge protrudes from the cartridge chamber; and
a chamber door to open and close the cartridge chamber and to switch to an open position to open the cartridge chamber based on the toner cartridge being in the pop-up position.

12. The image forming apparatus of claim 11, further comprising:
a locking member included in the chamber door and slidable between a locking position to lock the chamber door in a closed position to close the cartridge chamber and an unlocking position to allow the chamber door to be switched to the open position;
an elastic member to elastically bias the locking member toward the locking position; and
an inclined interference portion included on the locking member and inclined with respect to a pop-up direction of the toner cartridge to interfere with the toner cartridge in the pop-up position and to move the locking member to the unlocking position.

13. The image forming apparatus of claim 11, further comprising:
a locking lever located in the cartridge chamber and pivotable between a locking position to lock the chamber door in a closed position to close the cartridge chamber and an unlocking position to allow the chamber door to be switched to the open position to open the cartridge chamber;
an elastic member to apply an elastic force in a direction toward the locking position to the locking lever; and
an interference lever connected to the locking lever and rotatable between an interference position of interference with the toner cartridge in the pop-up position to pivot the locking lever to the unlocking position, and an escape position of interference with the toner cartridge mounted in the cartridge chamber to allow mounting of the toner cartridge.

14. The image forming apparatus of claim 11, further comprising a pop-up member to pop up the toner cartridge between the mounting position and the pop-up position

15. An image forming apparatus comprising:
a cartridge chamber including a toner cartridge;
a pop-up motor;
a coupling member including with a driving coupler to transmit a rotational force of the pop-up motor to the toner cartridge;
a push member connected to the coupling member to push the toner cartridge to a pop-up position in which the toner cartridge protrudes from the cartridge chamber based on the coupling member being reversely rotated;
a chamber door to open and close the cartridge chamber; and
a locking member to switch between a locking position to lock the chamber door in a closed position to close the cartridge chamber and an unlocking position to allow the chamber door to be switched to an open position to open the cartridge chamber by interfering with the toner cartridge in the pop-up position.
